(19) United States
(12) Patent Application Publication
(10) Pub. No.: US 2021/0055126 A1
(43) Pub. Date: Feb. 25, 2021

(54) CONTROL SYSTEM FOR WORK MACHINE, WORK MACHINE, AND CONTROL METHOD FOR WORK MACHINE

(71) Applicant: Komatsu Ltd., Tokyo (JP)

(72) Inventors: Daisuke Tanaka, Tokyo (JP); Tatsuya Shiga, Tokyo (JP)

(21) Appl. No.: 16/967,156

(22) PCT Filed: Feb. 5, 2019
(86) PCT No.: PCT/JP2019/004108

§ 371 Date: Aug. 4, 2020

(30) Foreign Application Priority Data
Apr. 20, 2018 (JP) 2018-081444

(51) Int. Cl. G01C 21/00; G01S 13/89; G01S 17/89; G05D 1/02; G08G 1/01

(52) U.S. Cl. CPC G01C 21/3819; G01S 13/89; G08G 1/0112; G05D 1/0274; G01S 17/89

(57) ABSTRACT

A control system for a work machine includes a position sensor that detects a position of a work machine traveling on a traveling road, a non-contact sensor that detects a position of an object around the work machine, and a map data creation unit that creates map data on the basis of a detection point on the object and detection data of the position sensor, the detection point being detected by the non-contact sensor and satisfying a prescribed height condition.

### FIELD

The present application relates to a control system for a work machine, a work machine, and a control method for a work machine.

### BACKGROUND

In a wide work site such as a mine, there is a case where a work machine that travels in an unmanned manner is used. A position of the work machine is detected by utilization of a global navigation satellite system (GNSS). When detection accuracy of the global navigation satellite system is decreased, there is a possibility that operation of the work machine is stopped and a productivity of the work site is decreased. Thus, a technology of creating map data of a work site, and calculating a position of a work machine by collating data detected by a non-contact sensor and the map data when detection accuracy of a global navigation satellite system is decreased is proposed.

### CITATION LIST

### Patent Literature

Patent Literature 1: WO 2016/060281

### SUMMARY

Technical Problem

Map data is created on the basis of data detected by a non-contact sensor mounted on a work machine that travels on a traveling road. The non-contact sensor detects an object, such as a bank on a traveling road, around a work machine. When the map data is created, there is a possibility that noise is included in the map data, for example, due to a shape of an object. When the map data includes noise, there is a possibility that a shape and position of an object indicated by the map data is deviated from a shape and position of an actual object due to the noise. As a result, there is a possibility that accuracy of calculated position measurement of the work machine is decreased when data detected by the non-contact sensor and the map data are collated.

An aspect of the present invention is to create highly accurate map data.

### Solution to Problem

According to an aspect of the present invention, a control system for a work machine, comprises: a position sensor that detects a position of a work machine traveling on a traveling road; a non-contact sensor that detects a position of an object around the work machine; and a map data creation unit that creates map data on the basis of a detection point on the object and detection data of the position sensor, the detection point being detected by the non-contact sensor and satisfying a prescribed height condition.

### Advantageous Effects of Invention

According to the present invention, highly accurate map data can be created.

### BRIEF DESCRIPTION OF DRAWINGS

FIG. 1 is a view schematically illustrating an example of a management system and a work machine according to a first embodiment.

FIG. 2 is a view schematically illustrating a work machine and a traveling road according to the first embodiment.

FIG. 3 is a view schematically illustrating a detection range of a non-contact sensor according to the first embodiment.

FIG. 4 is a view schematically illustrating the detection range of the non-contact sensor according to the first embodiment.

FIG. 5 is a functional block diagram illustrating a control system of a work machine according to the first embodiment.

FIG. 6 is a schematic view for describing processing by a map data creation unit according to the first embodiment.

FIG. 7 is a schematic view for describing processing by a filter unit according to the first embodiment.

FIG. 8 is a schematic view for describing processing by a map data creation unit according to a comparison example.

FIG. 9 is a flowchart illustrating a map data creating method according to the first embodiment.

FIG. 10 is a block diagram illustrating an example of a computer system.

FIG. 11 is a schematic view for describing processing by a map data creation unit according to a second embodiment.

FIG. 12 is a flowchart illustrating a map data creating method according to the second embodiment.

### DESCRIPTION OF EMBODIMENTS

In the following, embodiments according to the present invention will be described with reference to the drawings. However, the present invention is not limited to these. Components of the embodiments described in the following can be arbitrarily combined. Also, there is a case where a part of the components is not used.

### [1] First Embodiment

### Management System

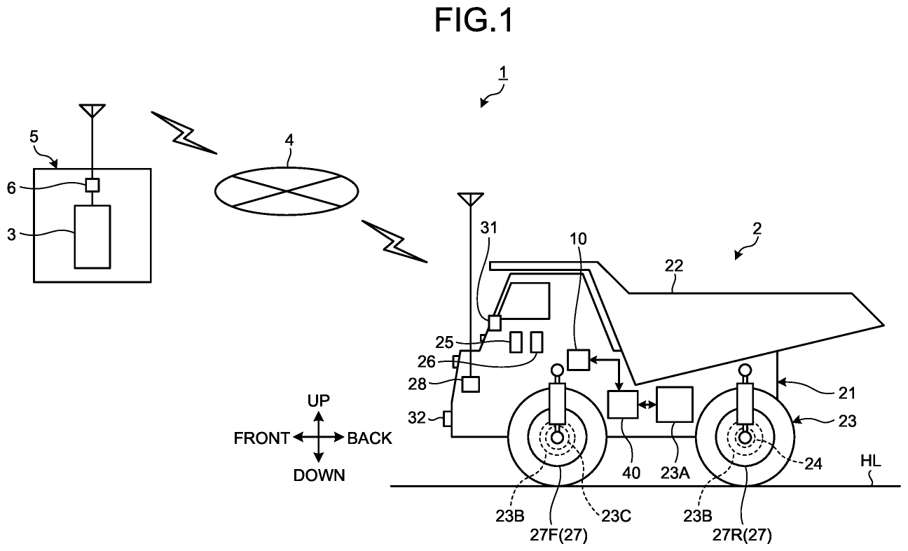

FIG. 1 is a view schematically illustrating an example of a management system 1 and a work machine 2 according to the present embodiment. The work machine 2 is an unmanned vehicle. The unmanned vehicle means a working vehicle that travels in an unmanned manner without depending on driving operation by a driver. The work machine 2 travels on the basis of traveling condition data from the management system 1.

The work machine 2 operates at a work site. In the present embodiment, the work site is a mine or a quarry. The work machine 2 is a dump truck that travels at the work site and that transports a load. The mine means a place or a plant where a mineral is mined. The quarry means a place or a plant where a stone is mined. As a load transported by the work machine 2, ore or dirt mined in the mine or the quarry is exemplified.

The management system 1 includes a management device 3 and a communication system 4. The management device 3 includes a computer system and is installed in a control facility 5 at the work site. The control facility 5 has an administrator. The communication system 4 performs communication between the management device 3 and the work machine 2. A wireless communication equipment 6 is connected to the management device 3. The communication system 4 includes the wireless communication equipment 6. The management device 3 and the work machine 2 communicate with each other wirelessly through the communication system 4. The work machine 2 travels on a traveling road HL at the work site on the basis of traveling condition data transmitted from the management device 3.

### Work Machine

The work machine 2 includes a vehicle body 21, a dump body 22 supported by the vehicle body 21, a traveling device 23 that supports the vehicle body 21, a speed sensor 24, a direction sensor 25, an attitude sensor 26, a wireless communication equipment 28, a position sensor 31, a non-contact sensor 32, a data processing device 10, and a traveling control device 40.

The vehicle body 21 includes a vehicle body frame and supports the dump body 22. The dump body 22 is a member on which a load is loaded.

The traveling device 23 includes wheels 27 and travels on the traveling road HL. The wheels 27 include front wheels 27F and rear wheels 27R. Tires are attached to the wheels 27. The traveling device 23 includes a drive device 23A, a brake device 23B, and a steering device 23C.

The drive device 23A generates driving force to accelerate the work machine 2. The drive device 23A includes an internal combustion engine such as a diesel engine. Note that the drive device 23A may include an electric motor. The driving force generated by the drive device 23A is transmitted to the rear wheels 27R, and the rear wheels 27R are rotated. The work machine 2 is self-propelled by the rotation of the rear wheels 27R. The brake device 23B generates braking force to decelerate or stop the work machine 2. The steering device 23C can adjust a traveling direction of the work machine 2. The traveling direction of the work machine 2 includes a direction of a front part of the vehicle body 21. The steering device 23C adjusts the traveling direction of the work machine 2 by steering the front wheels 27F.

In the following description, a direction parallel to a rotation axis of the rear wheels 27R is arbitrarily referred to as a vehicle width direction or a horizontal direction, a direction perpendicular to a contact surface of the wheels 27 (tire) is arbitrarily referred to as a vertical direction, and a direction orthogonal to both of the vehicle width direction and the vertical direction is arbitrarily referred to as a front-back direction. The vehicle width direction, the vertical direction, and the front-back direction are defined in a vehicle body coordinate system (local coordinate system) of the work machine 2.

The speed sensor 24 detects a traveling speed of the traveling device 23. Data detected by the speed sensor 24 includes traveling speed data indicating the traveling speed of the traveling device 23. The direction sensor 25 detects a direction of the work machine 2. Data detected by the direction sensor 25 includes direction data indicating a direction of the work machine 2. The direction of the work machine 2 is a traveling direction of the work machine 2. The direction sensor 25 includes a gyroscope sensor, for example. The attitude sensor 26 detects an attitude of the work machine 2. The attitude of the work machine 2 includes an inclination angle of the work machine 2 with respect to a horizontal plane. Data detected by the attitude sensor 26 includes attitude data indicating an attitude of the work machine 2. The attitude sensor 26 includes, for example, an inertial measurement unit (IMU).

The position sensor 31 detects a position of the work machine 2 traveling on the traveling road HL. Data detected by the position sensor 31 includes absolute position data indicating an absolute position of the work machine 2. The absolute position of the work machine 2 is detected by utilization of a global navigation satellite system (GNSS). The global navigation satellite system includes a global positioning system (GPS). The position sensor 31 includes a GPS receiver. The global navigation satellite system detects an absolute position of the work machine 2 which position is defined by coordinate data of latitude, longitude, and altitude. With the global navigation satellite system, an absolute position of the work machine 2 which position is defined in a global coordinate system is detected. The global coordinate system is a coordinate system fixed to the earth.

The non-contact sensor 32 detects a position of an object around the work machine 2. The non-contact sensor 32 scans at least a part of the object around the work machine 2 and detects a relative position with respect to a detection point DP on the object. Data detected by the non-contact sensor 32 includes relative position data indicating relative positions of the work machine 2 and the detection point DP. The non-contact sensor 32 is arranged, for example, in a lower part of the front part of the vehicle body 21. In the vehicle body coordinate system of the work machine 2, relative positions of an attachment position of the non-contact sensor 32 attached to the vehicle body 21 and a reference point on the vehicle body 21 is predetermined known data. The non-contact sensor 32 detects at least a part of the object around the work machine 2 in a non-contact manner. The object around the work machine 2 includes an object with which the work machine 2 traveling on the traveling road HL may interfere. As the object around the work machine 2, at least one of an obstacle that exists on the traveling road HL on which the work machine 2 travels, a rut in the traveling road HL, a bank BK that exists beside the traveling road HL, and a protrusion PR having a steep slope such as a cliff is exemplified. The non-contact sensor 32 functions as an obstacle sensor that detects an obstacle in front of the work machine 2 in a non-contact manner.

The non-contact sensor 32 can detect relative positions of the work machine 2 and the object. The non-contact sensor 32 includes a laser sensor that can scan the object with a laser beam and can detect relative positions of the work machine 2 and each of a plurality of detection points DP on the object. Note that the non-contact sensor 32 may be a radar sensor that can scan the object with a radio wave and can detect relative positions of the work machine 2 and each of the plurality of detection points DP on the object. In the following description, an energy wave such as a laser beam or a radio wave with which energy wave an object is scanned for detection of the object is arbitrarily referred to as a detection wave.

The wireless communication equipment 28 wirelessly communicates with the wireless communication equipment 6 connected to the management device 3. The communication system 4 includes the wireless communication equipment 28.

The data processing device 10 includes a computer system and is arranged in the vehicle body 21. The data processing device 10 processes the data detected by the position sensor 31 and the data detected by the non-contact sensor 32.

The traveling control device 40 includes a computer system and is arranged in the vehicle body 21. The traveling control device 40 controls a traveling state of the traveling device 23 of the work machine 2. The traveling control device 40 outputs an operation command including an accelerator command to operate the drive device 23A, a brake command to operate the brake device 23B, and a steering command to operate the steering device 23C. The drive device 23A generates driving force to accelerate the work machine 2 on the basis of the accelerator command output from the traveling control device 40. The brake device 23B generates braking force to decelerate or stop the work machine 2 on the basis of the brake command output from the traveling control device 40. On the basis of the steering command output from the traveling control device 40, the steering device 23C generates swing force to change a direction of the front wheels 27F in order to make the work machine 2 move straight ahead or swing.

### Traveling Road

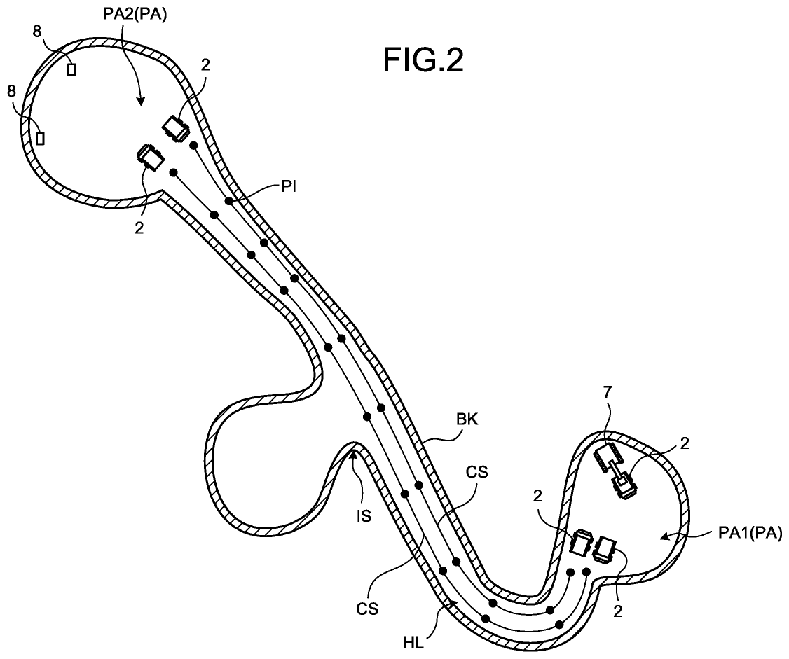

FIG. 2 is a view schematically illustrating the work machine 2 and the traveling road HL according to the present embodiment. The traveling road HL leads to a plurality of workplaces PA in the mine. The workplaces PA include at least one of a loading place PA1 and a dirt dumping place PA2. An intersection IS may be provided in the traveling road HL.

The loading place PA1 means an area where a loading operation of loading a load on the work machine 2 is performed. In the loading place PA1, a loader 7 such as an excavator operates. The dirt dumping place PA2 means an area where a dumping operation of dumping a load from the work machine 2 is performed. A crusher 8 is provided in the dirt dumping place PA2, for example.

The management device 3 sets a traveling condition of the work machine 2 on the traveling road HL. The work machine 2 travels on the traveling road HL on the basis of traveling condition data indicating the traveling condition transmitted from the management device 3.

The traveling condition data includes a target traveling speed and a target traveling course CS of the work machine 2. As illustrated in FIG. 2, the traveling condition data includes a plurality of points PI set at intervals on the traveling road HL. Each of the points PI indicates a target position of the work machine 2 which position is defined in the global coordinate system. Note that the points PI may be defined in the vehicle body coordinate system of the work machine 2.

The target traveling speed is set for each of the plurality of points PI. The target traveling course CS is defined by a line connecting the plurality of points PI.

### Non-Contact Sensor

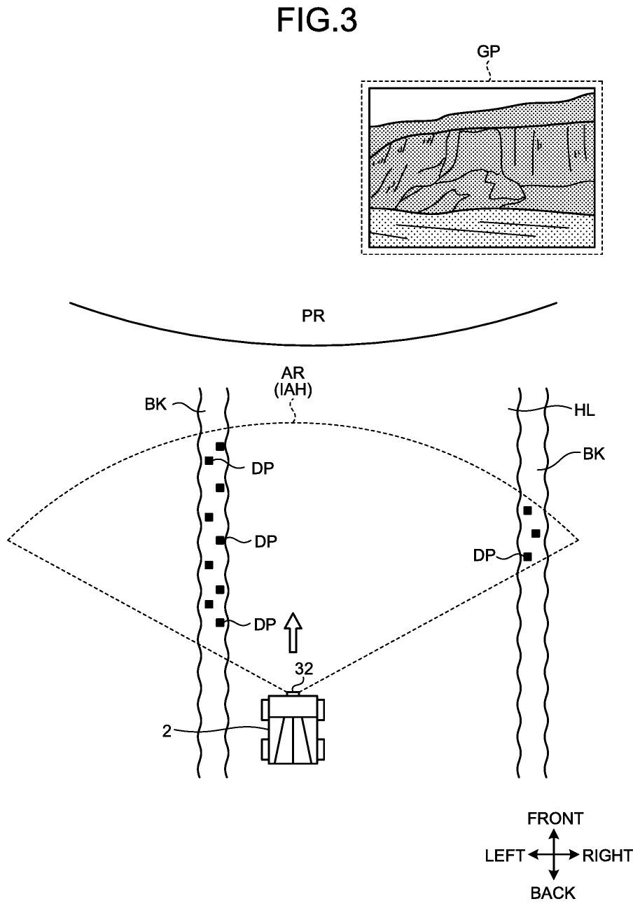

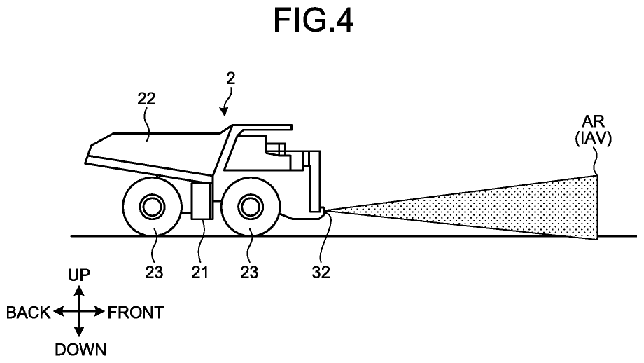

FIG. 3 and FIG. 4 are views schematically illustrating a detection range of the non-contact sensor 32 according to the present embodiment. The non-contact sensor 32 is arranged in the front part of the vehicle body 21 of the work machine 2. There may be a single or a plurality of non-contact sensors 32. A detection range AR of the non-contact sensor 32 is radial. The radial detection range AR is scanned with a detection wave. The non-contact sensor 32 scans an object in the detection range AR with the detection wave, and acquires point cloud data indicating a three-dimensional shape of the object. The point cloud data is an aggregate of a plurality of detection points DP on a surface of the object. The detection points DP include an irradiation point irradiated with the detection wave on the surface of the object. The non-contact sensor 32 scans at least a part of an object around the work machine 2 with a detection wave and detects a relative position with respect to each of a plurality of detection points DP on the object.

As illustrated in FIG. 3, the detection range AR includes an irradiation range IAH of a detection wave radially spread in the vehicle width direction from the vehicle body 21. Also, as illustrated in FIG. 4, the detection range AR includes an irradiation range IAV of a detection wave radially spread in the vertical direction from the vehicle body 21. The irradiation range IAH is spread more in the vehicle width direction as becoming away from the work machine 2. The irradiation range IAV is spread more in the vertical direction as becoming away from the work machine 2.

An object detected by the non-contact sensor 32 at least includes a protrusion PR that exists in front of the work machine 2. The protrusion PR is an object protruded to an upper side from a road surface on which the work machine 2 travels. Examples of the protrusion PR include a cliff existing at least partially around the traveling road HL, and a building such as the control facility 5. A height of the protrusion PR is larger than a height of the work machine 2. Note that the height of the protrusion PR may be smaller than the height of the work machine 2. In FIG. 3, an image GP of a cliff viewed from the work machine 2 is illustrated as an example of the protrusion PR. Note that the object may include a bank BK existing beside the traveling road HL. Banks BK are respectively provided on both sides of the traveling road HL.

The non-contact sensor 32 scans an object in a state in which the work machine 2 is traveling. Also, even when the object is arranged in the detection range AR, there is a possibility that a portion not irradiated with the detection wave is generated due to a shape of the object and relative positions of the object and the work machine 2.

### Control System

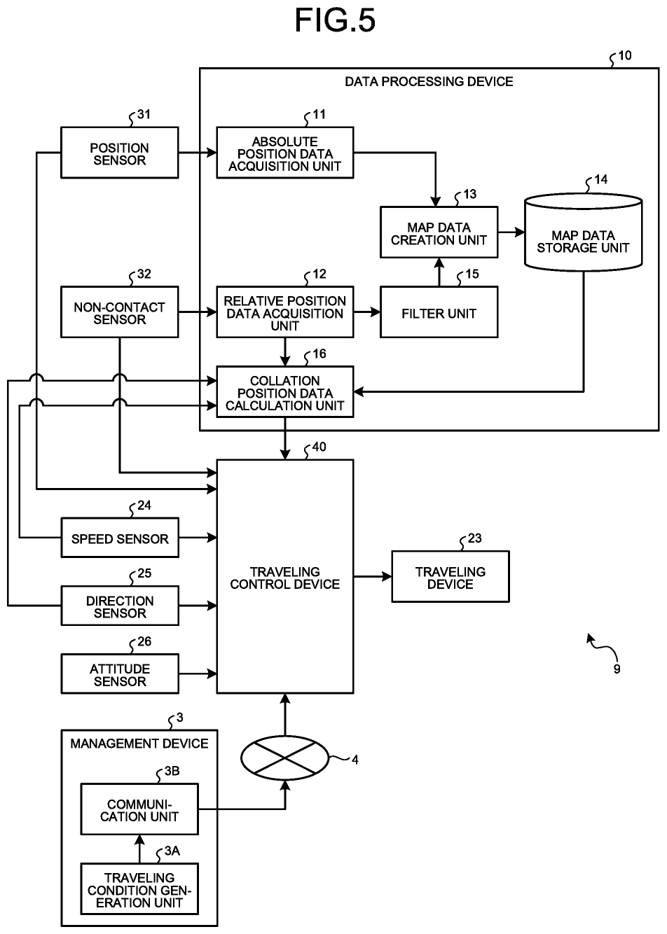

FIG. 5 is a functional block diagram illustrating a control system 9 of the work machine 2 according to the present embodiment. The control system 9 includes a data processing device 10 and a traveling control device 40. Each of the data processing device 10 and the traveling control device 40 can communicate with the management device 3 through the communication system 4.

The management device 3 includes a traveling condition generation unit 3A and a communication unit 3B. The traveling condition generation unit 3A generates traveling condition data indicating a traveling condition of the work machine 2. The traveling condition is determined, for example, by an administrator in the control facility. The administrator operates an input device connected to the management device 3. The traveling condition generation unit 3A generates traveling condition data on the basis of input data generated by operation of the input device. The communication unit 3B transmits the traveling condition data to the work machine 2. Through the communication system 4, the traveling control device 40 of the work machine 2 acquires the traveling condition data transmitted from the communication unit 3B.

### Data Processing Device

The data processing device 10 includes an absolute position data acquisition unit 11, a relative position data acquisition unit 12, a map data creation unit 13, a map data storage unit 14, a filter unit 15, and a collation position data calculation unit 16.

From the position sensor 31, the absolute position data acquisition unit 11 acquires absolute position data indicating an absolute position of the work machine 2. The position sensor 31 outputs a positioning signal indicating that the work machine 2 can be positioned, and a non-positioning signal indicating that the work machine 2 cannot be positioned. The absolute position data acquisition unit 11 acquires the positioning signal or the non-positioning signal from the position sensor 31.

The relative position data acquisition unit 12 acquires, from the non-contact sensor 32, relative position data indicating relative positions of the work machine 2 and each of the detection points DP on the object. The non-contact sensor 32 can detect a relative position with respect to each of the plurality of detection points DP by scanning at one time. The relative position data acquisition unit 12 acquires, from the non-contact sensor 32, relative position data between the work machine 2 and each of the plurality of detection points DP on the object.

The map data creation unit 13 creates map data of a work site on the basis of data detected by the position sensor 31 and data detected by the non-contact sensor 32. That is, the map data creation unit 13 creates map data of the work site on the basis of absolute position data of the work machine 2 which data is acquired by the absolute position data acquisition unit 11, and relative position data with respect to each of the plurality of detection points DP which data is acquired by the relative position data acquisition unit 12. The map data of the work site indicates existence/non-existence and a position of a detection point DP on the object around the work machine 2. In the present embodiment, the map data of the object includes map data of the banks BK and map data of the protrusion PR.

The map data creation unit 13 creates map data when the positioning signal is acquired. The map data creation unit 13 preferably creates the map data when detection accuracy of the absolute position of the work machine 2 which position is detected by the position sensor 31 is equal to or higher than prescribed accuracy (high accuracy). Creation of the map data includes processing of making the map data storage unit 14 store a detection point DP detected by the non-contact sensor 32.

The map data is created during traveling of the work machine 2 in a normal traveling mode (described later) when the positioning signal is acquired. It is preferable that the map data is created during traveling of the work machine 2 in the normal traveling mode when detection accuracy of the position sensor 31 is high. When the detection accuracy of the position sensor 31 is decreased, switching from the normal traveling mode to a collation traveling mode (described later) is performed, and the work machine 2 travels in the collation traveling mode.

In the present embodiment, the map data creation unit 13 creates map data on the basis of absolute position data of the work machine 2 which data is detected by the position sensor 31, direction data of the work machine 2 which data is detected by the direction sensor 25, and relative position data of detection points DP which data is detected by the non-contact sensor 32. The map data creation unit 13 integrates the absolute position data and direction data of the work machine 2 and the relative position data of the detection points DP, and creates map data of a bank BK and map data of a protrusion PR.

In the present embodiment, the map data creation unit 13 creates map data on the basis of detection points DP on the object, which detection points are detected by the non-contact sensor 32 and satisfy a prescribed height condition, and data detected by the position sensor 31.

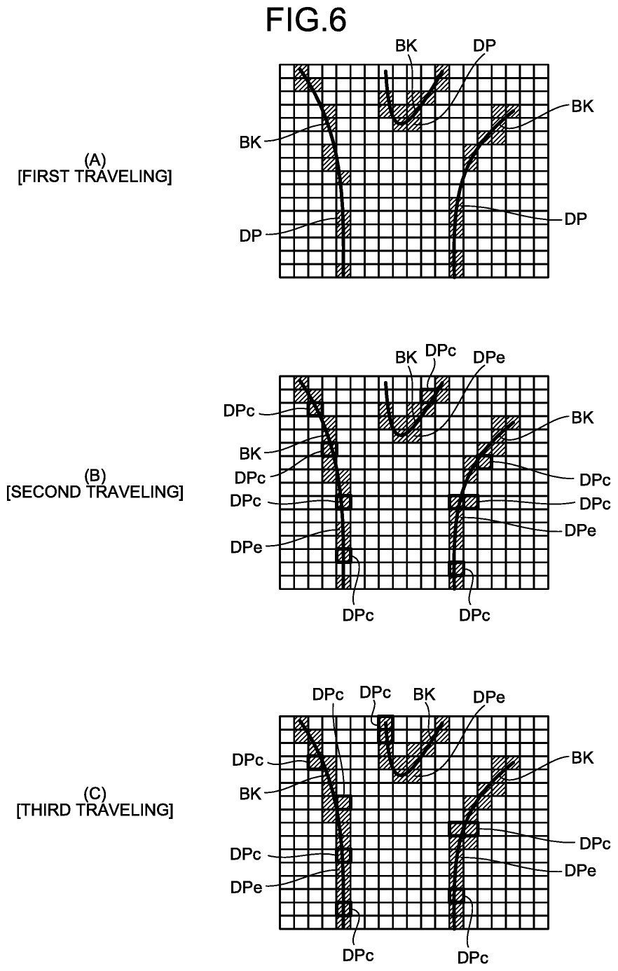

The map data storage unit 14 stores the map data created by the map data creation unit 13. The detection points DP include an existing detection point DPe included in the map data stored in the map data storage unit 14, and a current detection point DPc detected by the non-contact sensor 32. The existing detection point DPe means a detection point DP that defines the map data stored in the map data storage unit 14. As illustrated in FIG. 6 and the like, the current detection point DPc means a detection point DP in a current state which detection point is detected by the non-contact sensor 32 and acquired by the relative position data acquisition unit 12.

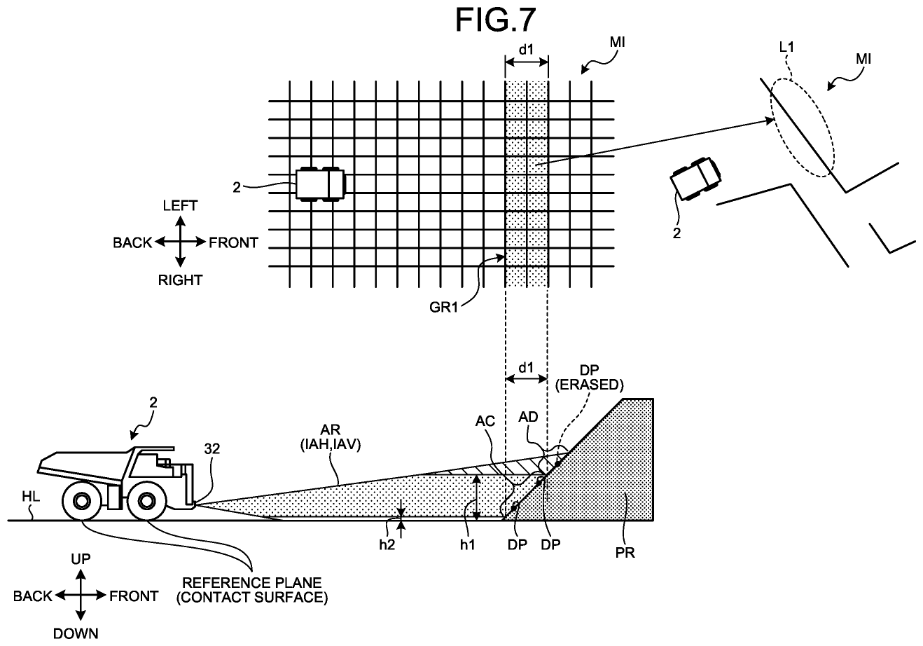

The filter unit 15 determines whether a detection point DP satisfies a height condition. A height of the detection point DP means a position of the detection point DP in the vertical direction in the vehicle body coordinate system. The height condition includes that the height is equal to or smaller than a height threshold h1. As illustrated in FIG. 7 and the like, the height threshold h1 is a threshold related to the height of the detection point DP and is previously determined. The height of the detection point DP indicates a height from a reference plane of the vehicle body coordinate system, and the height threshold h1 indicates a threshold related to the height from the reference plane of the vehicle body coordinate system. In the present embodiment, the reference plane of the vehicle body coordinate system is a contact surface of the wheels 27 (tire).

The filter unit 15 stores the height threshold h1. The filter unit 15 determines whether the height of the detection point DP is equal to or smaller than the height threshold h1 by comparing relative position data of the detection point DP (current detection point DPc) which data is acquired by the relative position data acquisition unit 12 with the height threshold h1. The relative position data of the detection point DP includes height data indicating the height of the detection point DP in the vehicle body coordinate system. The filter unit 15 calculates height data of the current detection point DPc in the vehicle body coordinate system on the basis of the relative position data of the detection point DP which data is acquired by the relative position data acquisition unit 12. In a case where the height of the detection point DP is equal to or smaller than the height threshold h1, the filter unit 15 determines that the current detection point DPc satisfies the height condition. In a case where the height of the detection point DP is larger than the height threshold h1, the filter unit 15 determines that the current detection point DPc does not satisfy the height condition.

The map data creation unit 13 creates map data by using a detection point DP that satisfies the height condition. The map data creation unit 13 creates map data in a prescribed cycle (for example, in every 0.1 [second]). The height condition determination by the filter unit 15 is performed in a prescribed cycle, and the map data creation unit 13 creates map data in the prescribed cycle on the basis of a result of the height condition determination by the filter unit 15.

The map data creation unit 13 makes the map data storage unit 14 store the map data created in the prescribed cycle. The map data stored in the map data storage unit 14 is updated in the prescribed cycle. The map data creation unit 13 creates map data by adding a current detection point DPc satisfying the height condition to the existing detection point DPe stored in the map data storage unit 14.

The collation position data calculation unit 16 collates the data detected by the non-contact sensor 32 and the map data created by the map data creation unit 13, and calculates collation position data indicating a collation position of the work machine 2. That is, the collation position data calculation unit 16 collates the relative position data of the current detection point DPc, which data is acquired by the relative position data acquisition unit 12, and the map data stored in the map data storage unit 14, and calculates the collation position data of the work machine 2. The collation position indicates an absolute position of the work machine 2 which position is calculated by the collation position data calculation unit 16.

The collation position data calculation unit 16 calculates the collation position and a direction of the work machine 2 on the basis of the traveling speed data detected by the speed sensor 24, the direction data detected by the direction sensor 25, and the relative position data of the detection points DP which data is detected by the non-contact sensor 32.

### Traveling Control Device

The traveling control device 40 controls the traveling device 23 in such a manner that the work machine 2 travels according to the traveling condition data generated by the management device 3. In the present embodiment, the traveling control device 40 makes the work machine 2 travel on the basis of a traveling mode that is at least one of a normal traveling mode of making the work machine 2 travel on the basis of the absolute position data detected by the position sensor 31, and a collation traveling mode of making the work machine 2 travel on the basis of the collation position data calculated by the collation position data calculation unit 16.

The normal traveling mode is a traveling mode executed when a positioning signal is acquired from the position sensor 31. When determining that the positioning signal is acquired from the position sensor 31, the traveling control device 40 controls the traveling device 23 on the basis of the absolute position data detected by the position sensor 31 and the traveling condition data. That is, in the normal traveling mode, the traveling control device 40 collates the absolute position data of the work machine 2 which data is detected by the position sensor 31 and coordinate data of a point PI, and controls a traveling state of the traveling device 23 in such a manner that a difference between the absolute position data of the work machine 2 and the coordinate data of the point PI is equal to or smaller than an acceptable value. The normal traveling mode is preferably performed when detection accuracy of an absolute position of the work machine 2 which absolute position is detected by the position sensor 31 is equal to or higher than prescribed accuracy.

The collation traveling mode is a traveling mode performed when a non-positioning signal is acquired from the position sensor 31 and detection accuracy of the absolute position of the work machine 2 which absolute position is detected by the position sensor 31 is decreased. The traveling control device 40 controls the traveling device 23 on the basis of the collation position data calculated by the collation position data calculation unit 16 and the traveling condition data when acquiring the non-positioning signal from the position sensor 31 and determining that the detection accuracy of the absolute position of the work machine 2 which absolute position is detected by the position sensor 31 is decreased. That is, in the collation traveling mode, the traveling control device 40 collates the collation position data of the work machine 2 which data is calculated by the collation position data calculation unit 16 and the coordinate data of the point PI, and controls a traveling state of the traveling device 23 in such a manner that a difference between the collation position data of the work machine 2 and the coordinate data of the point PI is equal to or smaller than the acceptable value.

Note that examples of a situation in which the detection accuracy of the position sensor 31 is decreased include an ionospheric anomaly due to a solar flare, a communication abnormality with respect to the global navigation satellite system, and the like. For example, at an open-pit work site in a mining site, a possibility that a communication abnormality with respect to the global navigation satellite system is generated is high.

### Processing by Map Data Creation Unit

FIG. 6 is a schematic view for describing processing by the map data creation unit 13 according to the present embodiment. Note that in the example illustrated in FIG. 6, it is assumed that an object detected by the non-contact sensor 32 is a bank BK. Note that an object may be a protrusion PR.

Map data includes grid data including a plurality of grids. A detection point DP is defined by one grid. The detection point DP is binary data indicating existence of the bank BK. When a bank BK is detected at a detection point DP, “1” is input to a grid as the detection point DP. In a case where no bank BK is detected, “0” is input to a grid.

In a work site such as a mine, the work machine 2 often travels on the same traveling road HL for a plurality of times. The map data creation unit 13 creates map data on the basis of a detection point DP acquired each time of traveling in a plurality of times of traveling of the work machine 2 on the same place.

FIG. 6(A) is a view schematically illustrating detection points DP acquired when the work machine 2 travels on a specific place in the traveling road HL for the first time. The non-contact sensor 32 scans an object in a state in which the work machine 2 is traveling. As described above, detection points DP are sparsely detected on a surface of the bank BK. The map data creation unit 13 creates map data as illustrated in FIG. 6(A) on the basis of the detection points DP detected sparsely. The map data created by the map data creation unit 13 is stored in the map data storage unit 14.

FIG. 6(B) is a view schematically illustrating detection points DP acquired when the work machine 2 travels on the specific place in the traveling road HL for the second time. In the second traveling, provided that detection accuracy of the position sensor 31 is equal to or higher than prescribed accuracy, the map data creation unit 13 can determine whether the specific place traveled in the first traveling is traveled on the basis of absolute position data of the work machine 2 which data is acquired by the absolute position data acquisition unit 11. The map data creation unit 13 integrates the detection points DP detected in the second traveling with the map data created in the first traveling. That is, the map data creation unit 13 creates map data in such a manner that a plurality of current detection points DPc that indicates detection points DP in a current state and that is acquired by the relative position data acquisition unit 12 in the second traveling is added to existing detection points DPe of the map data stored in the map data storage unit 14. In FIG. 6(B), the map data stored in the map data storage unit 14 is defined by the existing detection points DPe. The map data creation unit 13 creates the map data in such a manner that the current detection points DPc acquired in the second traveling are added to the existing detection points DPe acquired in the first traveling.

FIG. 6(C) is a view schematically illustrating detection points DP acquired when the work machine 2 travels on the specific place in the traveling road HL for the third time. The map data creation unit 13 integrates the detection points DP detected in the third traveling with the map data created in the first and second traveling. That is, the map data creation unit 13 creates map data in such a manner that a plurality of current detection points DPc that indicates detection points DP in a current state and that is acquired by the relative position data acquisition unit 12 in the third traveling is added to the existing detection points DPe of the map data stored in the map data storage unit 14.

In such a manner, when the work machine 2 travels on the same place for a plurality of times, detection points DP acquired each time of traveling are accumulated. As the number of times of traveling is increased, map data corresponding to a position and shape of an actual bank BK is constructed.

### Processing by Filter Unit

FIG. 7 is a schematic view for describing the processing by the filter unit 15 according to the present embodiment. The work machine 2 travels on the traveling road HL. When a protrusion PR exists in front of the work machine 2 traveling on the traveling road HL, the non-contact sensor 32 detects the protrusion PR. A surface (wall surface) of the protrusion PR facing the non-contact sensor 32 is inclined upward in such a manner as to be separated from the work machine 2.

A detection range AR of the non-contact sensor 32 is radially spread in the vertical direction. Scanning with a detection wave is performed in the detection range AR. The non-contact sensor 32 scans a protrusion PR in the detection range AR with the detection wave, and acquires point cloud data indicating a three-dimensional shape of the protrusion PR. The point cloud data is an aggregate of a plurality of detection points DP on a surface of the protrusion PR.

The relative position data acquisition unit 12 acquires data detected by the non-contact sensor 32. The data detected by the non-contact sensor 32 includes relative position data of the detection points DP.

On the basis of the relative position data of the detection points DP which data is acquired by the relative position data acquisition unit 12, the filter unit 15 calculates height data indicating heights of the detection points DP in the vehicle body coordinate system. The filter unit 15 calculates height data of each of the plurality of detection points DP existing in the detection range AR.

The filter unit 15 determines whether each of the plurality of detection points satisfies a height condition. The height condition includes that a height of a detection point DP is equal to or smaller than a height threshold h1. The height of the detection point DP indicates a height from a reference plane of the vehicle body coordinate system, and the height threshold h1 indicates a threshold related to the height from the reference plane of the vehicle body coordinate system. The reference plane of the vehicle body coordinate system is a contact surface of the wheels 27 (tire). The filter unit 15 compares the height data of the detection point DP with the predetermined height threshold h1, and determines whether a height of each of the plurality of detection points DP is equal to or smaller than the height threshold h1.

The filter unit 15 excludes a detection point DP that does not satisfy the height condition among the plurality of detection points DP. That is, the filter unit 15 excludes the detection point DP existing in a position higher than the height threshold h1. In the example illustrated in FIG. 7, the filter unit 15 excludes a detection point DP existing in a height condition unsatisfied region AD among the plurality of detection points DP on the surface of the protrusion PR.

The map data creation unit 13 creates map data by using detection points DP determined by the filter unit 15 to satisfy the height condition. That is, the map data creation unit 13 creates the map data by using the detection points DP equal to or smaller than the height threshold h1. The detection point DP that is determined not to satisfy the height condition and excluded by the filter unit 15 is not reflected on the map data. In the example illustrated in FIG. 7, the filter unit 15 creates map data by using detection points DP existing in a height condition satisfied region AC among the plurality of detection points DP on the surface of the protrusion PR.

The creation of map data includes processing of adding a current detection point DPc to map data stored in the map data storage unit 14. The map data creation unit 13 creates map data by adding a current detection point DPc equal to or smaller than the height threshold h1 to an existing detection point DPe of the map data stored in the map data storage unit 14.

Map data MI includes grid data including a plurality of grids. A detection point DP is defined by one grid. As illustrated in FIG. 7, the map data MI includes a plurality of grids arranged in a matrix in a plane parallel to a horizontal plane. In the present embodiment, “1” is input to a grid indicating a detection point DP that satisfies the height condition. “0” is input to a grid indicating a detection point DP that does not satisfy the height condition.

Note that in the present embodiment, a height threshold h2 smaller than the height threshold h1 is set. The height threshold h2 indicates a threshold related to a height from a reference plane (contact surface) of the vehicle body coordinate system. The filter unit 15 stores the height threshold h2. The height threshold h2 is a height that can be regarded as a height equivalent to that of a road surface of the traveling road HL. A traveling road in a mine is unpaved, and there is a rock or rut to an extent that the work machine 2 can get over. A height of the rock or rut to an extent that the work machine 2 can get over is equal to or smaller than the height threshold h2, and the rock or rut is an object to an extent that can be ignored in traveling of the work machine 2. Even when an object having a height equal to or smaller than the height threshold h2 exists on the road surface of the traveling road HL, the work machine 2 can travel without trouble. In the present embodiment, the filter unit 15 excludes a detection point DP equal to or smaller than the height threshold h2. That is, in the present embodiment, the filter unit 15 excludes a detection point DP larger than the height threshold h1 and a detection point DP equal to or smaller than the height threshold h2. The map data creation unit 13 creates map data by using detection points DP that are equal to or smaller than the height threshold h1 and that are larger than the height threshold h2.

By exclusion of a detection point DP on an object that can be regarded to have a height equivalent to that of the road surface of the traveling road HL, “0” is input to a grid indicating the road surface on which the work machine 2 travels. In the map data, when “1” is input not only for a bank BK and a protrusion PR but also for a grid indicating a road surface on which the work machine 2 travels, it is determined that there is an obstacle on the road surface. Thus, there is a possibility that it becomes difficult for the work machine 2 to travel in the collation traveling mode. In the present embodiment, since the detection point DP equal to or smaller than the height threshold h2 is excluded, the work machine 2 can smoothly travel on the traveling road HL in the collation traveling mode.

A grid region GR1 extending in the vehicle width direction is formed in the map data MI by detection points DP that satisfy the height condition. The grid region GR1 includes a plurality of detection points DP that satisfies the height condition. The detection point DP that does not satisfy the height condition is excluded by the filter unit 15 and is not used for creation of the map data MI (grid region GR1). Thus, a width d1 of the grid region GR1 in a front-back direction is defined on the basis of the detection points DP that satisfy the height condition.

Since the map data MI according to the present embodiment is created on the basis of the detection points DP that satisfy the height condition, a width d1 of the grid region GR1 in a direction orthogonal to the surface of the protrusion PR can be reduced. That is, the number of grids to which “1” is input can be reduced in the direction orthogonal to the surface of the protrusion PR. Thus, as illustrated in FIG. 7, it is possible to reduce a thickness of a line L1 that defines the surface of the protrusion PR in the map data MI.

The map data MI is created for a purpose of controlling a contact between the work machine 2 traveling in the collation traveling mode and objects (bank BK and protrusion PR). A protrusion PR existing in a position higher than the height threshold h1 is unlikely to come into contact with the work machine 2. Thus, a detection point DP existing in a position higher than the height threshold h1 can be regarded as noise.

When the detection point DP (current detection point DPc) regarded as noise is added to the map data stored in the map data storage unit 14, there is a possibility that many grids expressing the surface of the protrusion PR are arranged in the direction orthogonal to the surface of the protrusion PR in the map data. As a result, there is a possibility that the surface of the protrusion PR is indicated by a thick line in the map data.

That is, when a detection point DP regarded as noise is added to the map data, the map data is created on the basis of a detection point DP that is originally unnecessary (detection point DP larger than height threshold h1). Thus, there is a possibility that a phenomenon that a line indicating a surface of a protrusion PR becomes thick is generated and a shape and position of the protrusion PR indicated by the map data are deviated from a shape and position of an actual protrusion PR. As a result, when data detected by the non-contact sensor 32 and the map data are collated, there is a possibility that accuracy of calculated position measurement of the work machine 2 is decreased.

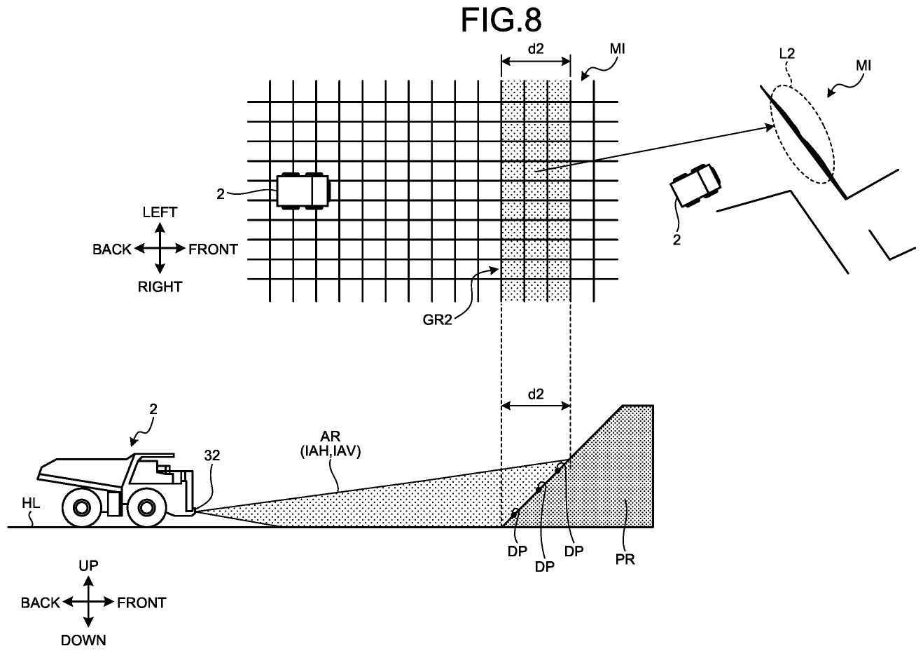

FIG. 8 is a schematic view for describing processing by a map data creation unit 13 according to a comparison example. In FIG. 8, map data created without height condition determination by a filter unit 15 is illustrated. That is, FIG. 8 is a view illustrating map data created by utilization of not only a detection point DP equal to or smaller than a height threshold h1 but also a detection point DP larger than the height threshold h1.

A detection range AR is spread radially in a vertical direction. Thus, a dimension of the detection range AR in the vertical direction becomes large on a surface of a protrusion PR.

A grid region GR2 extending in a vehicle width direction is formed in map data MI by the detection point DP equal to or smaller than the height threshold h1 and the detection point DP larger than the height threshold h1. When the map data is created on the basis of both of the detection point DP equal to or smaller than the height threshold h1 and the detection point DP larger than the height threshold h1, many grids expressing the surface of the protrusion PR are arranged in a direction orthogonal to a surface of the protrusion PR in the map data. That is, the number of grids to which “1” is input is increased in the direction orthogonal to the surface of the protrusion PR, and a width d2 of the grid region GR2 is increased. As a result, there is a possibility that the surface of the protrusion PR is indicated by a thick line L2 in the map data and a shape and position of the protrusion PR indicated in the map data are deviated from a shape and position of an actual protrusion PR.

In the present embodiment, the filter unit 15 excludes a detection point DP larger than the height threshold h1. The map data creation unit 13 creates map data by using a detection point DP equal to or smaller than the height threshold h1, and does not create map data by using a detection point DP larger than the height threshold h1. This controls reflection, on map data, of a detection point DP (current detection point DPc) regarded as noise and controls creation of map data deviated from a shape and position of an actual protrusion PR.

### Map Data Creating Method

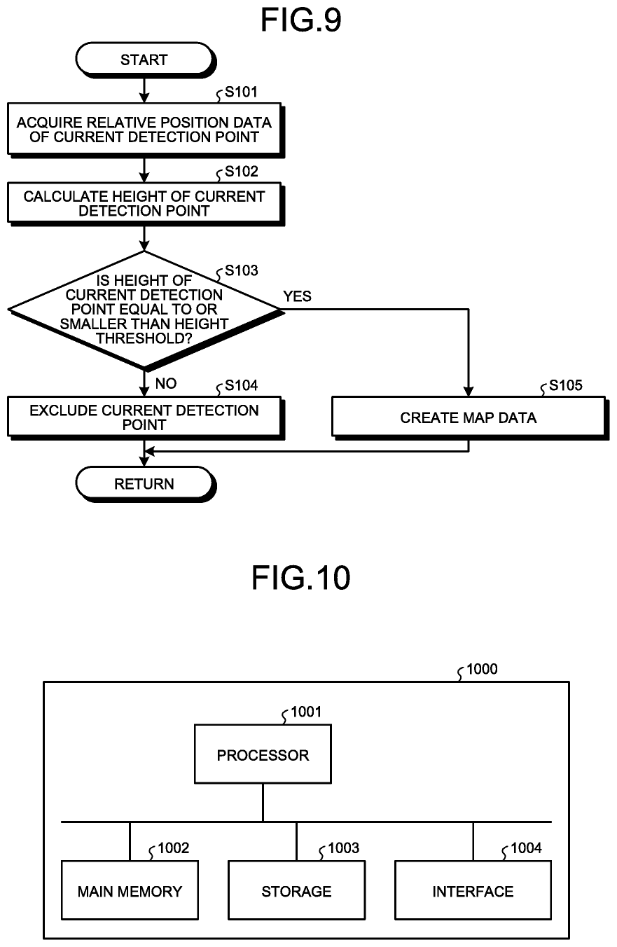

Next, a map data creating method according to the present embodiment will be described. FIG. 9 is a flowchart illustrating the map data creating method according to the present embodiment.

As a premise that the map data creating method illustrated in FIG. 9 is performed, it is assumed that the work machine 2 has already traveled a specific place on the traveling road HL in the normal traveling mode and map data is stored in the map data storage unit 14.

Also, in the following description, one current detection point DPc will be described in order to simplify the description. Note that the data processing device 10 repeatedly executes the processing illustrated in FIG. 9 in a prescribed cycle for each of a plurality of current detection points DPc during traveling of the work machine 2.

The position sensor 31 detects an absolute position of the work machine 2 while the work machine 2 travels on a specific place. The non-contact sensor 32 scans at least a part of an object with a detection wave. Data detected by the position sensor 31 and data detected by the non-contact sensor 32 are output to the data processing device 10.

The relative position data acquisition unit 12 acquires relative position data of a current detection point DPc from the non-contact sensor 32 (Step S101).

The filter unit 15 calculates height data indicating a height of the current detection point DPc on the basis of the relative position data that is acquired by the relative position data acquisition unit 12 and that indicates relative positions of the work machine 2 and the current detection point DPc of the object (Step S102).

The filter unit 15 determines whether the height of the current detection point DPc is equal to or smaller a height threshold h1 (Step S103).

In a case where it is determined in Step S103 that the height of the current detection point DPc is larger than the height threshold h1 (Step S103: No), the filter unit 15 excludes the current detection point DPc larger than the height threshold h1 (Step S104).

In a case where it is determined in Step S103 that the height of the detection point DP is equal to or smaller than the height threshold h1 (Step S103: Yes), the map data creation unit 13 creates map data by using the current detection point DPc equal to or smaller the height threshold h1 (Step S105).

Note that the map data may be created by utilization of a detection point DP that is equal to or smaller than the height threshold h1 and that is larger than the height threshold h2, as described above. In that case, in Step S103, the filter unit 15 determines whether a height of a current detection point DPc is equal to or smaller than the height threshold h1 and is larger than the height threshold h2.

Note that map data may be created by utilization of a detection point DP that satisfies at least one of a first height condition indicating that a height is equal to or smaller than the height threshold h1 and a second height condition indicating that a height is larger than the height threshold h2. In that case, in Step S103, the filter unit 15 determines whether a height of a current detection point DPc is equal to or smaller than the height threshold h1 or is larger than the height threshold h2.

### Computer System

FIG. 10 is a block diagram illustrating an example of a computer system 1000. Each of the management device 3, the data processing device 10, and the traveling control device 40 described above includes a computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. The above-described function of the management device 3, function of the data processing device 10, and function of the traveling control device 40 are stored as programs in the storage 1003. The processor 1001 reads a program from the storage 1003, extracts the program into the main memory 1002, and executes the above-described processing according to the program. Note that the program may be distributed to the computer system 1000 through a network.

### Effect

As described above, according to the present embodiment, map data is created on the basis of detection points DP equal to or smaller than a height threshold h1, and map data is not created by utilization of a detection point DP that is larger than the height threshold h1 and is regarded as noise. This controls inclusion of noise in the map data in creation of the map data. Since an influence of noise is controlled in creation of map data and highly-accurate map data can be created, a decrease in accuracy of calculated position measurement of the work machine 2 is controlled when data detected by the non-contact sensor 32 and the map data are collated. Thus, for example, when detection accuracy of the position sensor 31 is decreased and the work machine 2 is made to travel while collation of the data detected by the non-contact sensor 32 and the map data is performed, the work machine 2 can travel accurately according to traveling condition data.

Also, according to the present embodiment, the number of grids to which “1” is input can be reduced, and a region defined by the grids to which “1” is input is reduced. Thus, volume of data in the map data storage unit 14 can be reduced.

### [2] Second Embodiment

The second embodiment will be described. In the following description, the same sign is assigned to a configuration element identical to that of the above-described embodiment, and a description thereof is simplified or omitted.

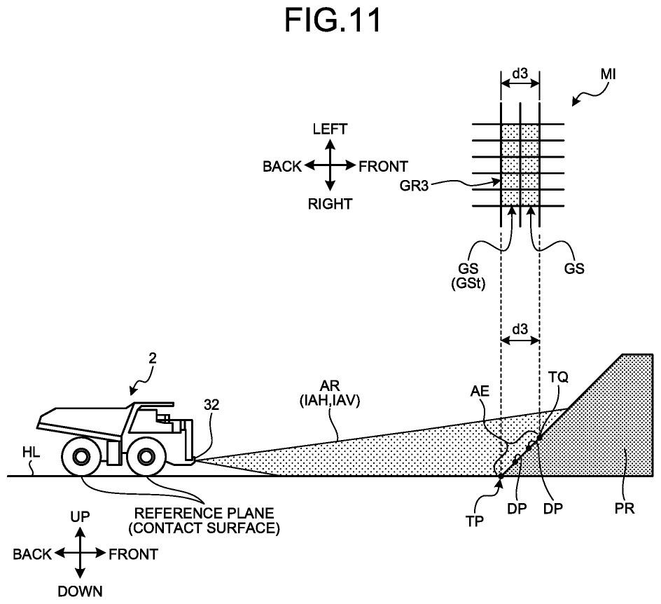

FIG. 11 is a schematic view for describing processing by a map data creation unit 13 according to the present embodiment. As illustrated in FIG. 11, a protrusion PR exists in front of a work machine 2 traveling on a traveling road HL. A non-contact sensor 32 detects a position of a boundary TP between a ground of the traveling road HL and a surface of the protrusion PR. In the present embodiment, the position of the boundary TP detected by the non-contact sensor 32 means a position of the boundary TP, which faces the work machine 2 (non-contact sensor 32) and is arranged in a detection range AR, on the surface of the protrusion PR.

An inclination angle of a road surface of the traveling road HL and an inclination angle of the surface of the protrusion PR are different. The boundary TP indicates an inflection point between the road surface of the traveling road HL and the surface of the protrusion PR.

A relative position data acquisition unit 12 acquires relative position data indicating relative positions of the work machine 2 and the boundary TP. Also, the relative position data acquisition unit 12 acquires relative position data indicating relative positions of the work machine 2 and a plurality of detection points DP on the surface of the protrusion PR. A filter unit 15 determines, for each of the plurality of detection points DP on the surface of the protrusion PR, whether a height condition is satisfied.

In the present embodiment, the height condition includes existence in a prescribed region AE in a prescribed distance d3 from the boundary TP on the surface of the protrusion PR. The prescribed region AE is a partial region on the surface of the protrusion PR between the boundary TP and a position TQ that is separated from the boundary TP for the prescribed distance d3 on a front side. The prescribed distance d3 is a distance in a front-back direction in a vehicle body coordinate system. In each of the front-back direction and a vertical direction, the prescribed distance d3 is shorter than a dimension of the detection range AR on the surface of the protrusion PR.

The prescribed distance d3 is determined on the basis of a dimension of a grid that defines map data. In the present embodiment, the prescribed distance d3 is equal to the sum of dimensions of a plurality of prescription grids GS arranged in the front-back direction of the vehicle body coordinate system in order to prescribe a height condition. The prescription grids GS are arranged on a front side of the boundary TP. The prescribed region AE is prescribed by the prescription grids GS.

The filter unit 15 determines whether a detection point DP acquired by the relative position data acquisition unit 12 exists in the prescribed region AE. That is, the filter unit 15 determines whether the detection point DP acquired by the relative position data acquisition unit 12 corresponds to a prescription grid GS.

At least one of the prescription grids GS corresponds to the position of the boundary TP. In the following description, a prescription grid GS corresponding to the boundary TP will be arbitrarily referred to as a boundary grid GSt.

In the present embodiment, two prescription grids GS are arranged in the front-back direction of the vehicle body coordinate system. The prescribed distance d3 is equal to the sum of dimensions of the two prescription grids GS. That is, in the present embodiment, the prescribed number of prescription grids GS are set in the front-back direction in such a manner as to include the boundary TP. The number of prescription grids GS in the front-back direction (that is, prescribed distance d3) is predetermined and stored in the filter unit 15.

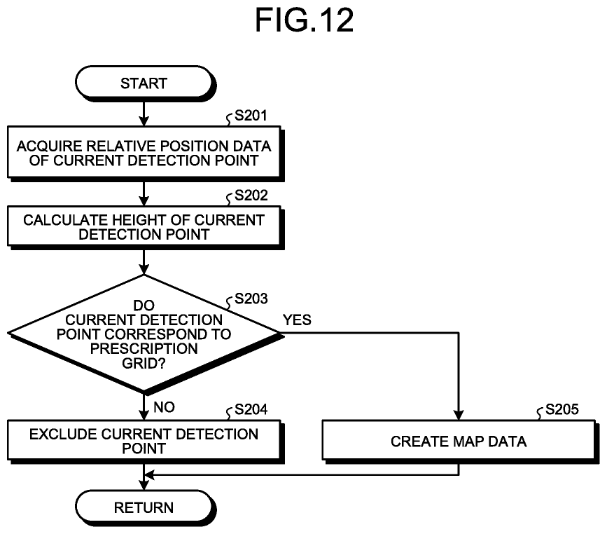

FIG. 12 is a flowchart illustrating a map data creating method according to the present embodiment. In the following description, one current detection point DPc will be described in order to simplify the description. Note that a data processing device 10 repeatedly executes processing illustrated in FIG. 12 in a prescribed cycle for each of a plurality of current detection points DPc during traveling of the work machine 2.

A position sensor 31 detects an absolute position of the work machine 2 while the work machine 2 travels on the traveling road HL. The non-contact sensor 32 scans at least a part of an object (protrusion PR) with a detection wave. Data detected by the position sensor 31 and data detected by the non-contact sensor 32 are output to the data processing device 10.

The relative position data acquisition unit 12 acquires relative position data of a current detection point DPc from the non-contact sensor 32 (step S201).

The filter unit 15 calculates height data indicating a height of the current detection point DPc on the basis of relative position data that is acquired by the relative position data acquisition unit 12 and that indicates relative positions of the work machine 2 and the current detection point DPc on the object (step S202).

The filter unit 15 determines whether the current detection point DPc corresponds to a prescription grid GS (Step S203).

When it is determined in Step S203 that the current detection point DPc does not correspond to the prescription grid GS (Step S203: No), the filter unit 15 excludes the current detection point DPc that does not correspond to the prescription grid GS (Step S204).

In a case where it is determined in Step S203 that the current detection point DPc corresponds to the prescription grid GS (Step S203: Yes), the map data creation unit 13 creates map data by using the current detection point DPc that corresponds to the prescription grid GS (Step S205).

As described above, according to the present embodiment, since the boundary TP is detected, the filter unit 15 can determine whether a detection point DP satisfies a height condition on the basis of a prescribed distance d3 (number of prescription grid GS in front-back direction) determined previously. The map data creation unit 13 creates map data by using a detection point DP (current detection point DPc) that satisfies a height condition. This controls thickening of a line indicating a surface of the protrusion PR in the map data. Also, by changing the prescribed distance d3 (number of prescription grid GS in front-back direction), it is possible to arbitrarily adjust a thickness of a line of the surface of the protrusion PR in the map data. Reflection, on map data, of a detection point DP (current detection point DPc) regarded as noise is controlled and creation of map data deviated from a shape and position of an actual protrusion PR is controlled similarly in the present embodiment.

Also in the present embodiment, the number of grids to which “1” is input can be reduced, and a region defined by the grids to which “1” is input is reduced. Thus, volume of data in the map data storage unit 14 can be reduced.

Note that in the present embodiment, the number of prescription grids GS in the front-back direction is not limited to two. The number of prescription grids GS in the front-back direction can be arbitrarily set within a range in which a shape of a surface and position of a protrusion PR indicated in map data are not deviated excessively from a shape of a surface and position of an actual protrusion PR.

### [3] Different Embodiment

Note that in the above-described embodiments, map data created by a map data creation unit 13 may be displayed on a display device. The display device may be arranged in an operating room of a work machine 2. Arrangement may be in a control facility 5. On the basis of a correspondence condition, the display device may change a display form of a grid included in map data. For example, the display device may display, in different colors or densities, a current detection point PDc that corresponds to an existing detection point DPe described in the above-described first embodiment and a current detection point PDc that does not correspond to the existing detection point DPe. Also, the display device may display, in different colors or densities, a current detection point PDc with the number of times of detection described in the above-described second embodiment and third embodiment being equal to or larger than a threshold of the number of times of detection, and a current detection point PDc with the number of times of detection being equal to or smaller than the threshold of the number of times of detection.

Note that in the above-described embodiment, map data created by a data processing device 10 mounted on each of a plurality of work machines 2 may be transmitted to a management device 3. The management device 3 may integrate a plurality of pieces of map data created in each of the plurality of work machines 2. Also, the management device 3 may deliver the integrated map data to each of the plurality of work machines 2. Each of the plurality of work machines 2 may travel on the basis of the distributed map data. In a work site such as a mine, there is a high possibility that each of the plurality of work machines 2 travels on the same traveling road HL for many times. Thus, a possibility that the map data that is created by the data processing device 10 mounted on each of the plurality of work machines 2 and is integrated by the management device 3 is highly accurate map data is high. Each of the plurality of work machines 2 can travel in a collation traveling mode on the basis of the highly-accurate integrated map data.

Note that a collation position data calculation unit 16 may be omitted in the above-described embodiment.

Note that in the above-described embodiment, at least a part of a function of a data processing device 10 may be provided in a management device 3, or at least a part of a function of a management device 3 may be provided in at least one of a data processing device 10 and a traveling control device 40. For example, in the above-described embodiment, a management device 3 may have functions of a map data creation unit 13, a map data storage unit 14, and a filter unit 15, and map data created by the management device 3 may be transmitted to a traveling control device 40 of a work machine 2 through a communication system 4.

### REFERENCE SIGNS LIST

1 MANAGEMENT SYSTEM

2 WORK MACHINE

3 MANAGEMENT DEVICE

3A TRAVELING CONDITION GENERATION UNIT

3B COMMUNICATION UNIT

4 COMMUNICATION SYSTEM

5 CONTROL FACILITY

6 WIRELESS COMMUNICATION EQUIPMENT

7 LOADER

8 CRUSHER

9 CONTROL SYSTEM

10 DATA PROCESSING DEVICE

11 ABSOLUTE POSITION DATA ACQUISITION UNIT

12 RELATIVE POSITION DATA ACQUISITION UNIT

13 MAP DATA CREATION UNIT

14 MAP DATA STORAGE UNIT

15 FILTER UNIT

16 COLLATION POSITION DATA CALCULATION UNIT

21 VEHICLE BODY

22 DUMP BODY

23 TRAVELING DEVICE

23A DRIVE DEVICE

23B BRAKE DEVICE

23C STEERING DEVICE

24 SPEED SENSOR

25 DIRECTION SENSOR

26 ATTITUDE SENSOR

27 WHEEL

27F FRONT WHEEL

27R REAR WHEEL

28 WIRELESS COMMUNICATION EQUIPMENT

31 POSITION SENSOR

32 NON-CONTACT SENSOR

40 TRAVELING CONTROL DEVICE

AC HEIGHT CONDITION SATISFIED REGION

AD HEIGHT CONDITION UNSATISFIED REGION

AE PRESCRIBED REGION

AR DETECTION RANGE

CS TARGET TRAVELING COURSE

DP DETECTION POINT

DPc CURRENT DETECTION POINT

DPe EXISTING DETECTION POINT

GP IMAGE

GS PRESCRIPTION GRID

GSt BOUNDARY GRID

HL TRAVELING ROAD

IAH IRRADIATION RANGE

IAV IRRADIATION RANGE

IS INTERSECTION

L1 LINE

L2 LINE

PA WORKPLACE

PA1 LOADING PLACE

PA2 DIRT DUMPING PLACE

PI POINT

PR PROTRUSION

TP BOUNDARY

TQ POSITION

1. A control system for a work machine, comprising:
a position sensor that detects a position of a work machine traveling on a traveling road;
a non-contact sensor that detects a position of an object around the work machine; and
a map data creation unit that creates map data on the basis of a detection point on the object and detection data of the position sensor, the detection point being detected by the non-contact sensor and satisfying a prescribed height condition.

2. The control system for a work machine according to claim 1, wherein
the height condition includes a height being equal to or smaller than a height threshold.

3. The control system for a work machine according to claim 1, wherein
the object exists in front of the work machine traveling on the traveling road,
the non-contact sensor detects a position of a boundary between a road surface of the traveling road and a surface of the object, and
the height condition includes existence in a prescribed region in a prescribed distance from the boundary on the surface of the object.

4. The control system for a work machine according to claim 1, comprising
a map data storage unit that stores the map data, wherein
the detection point includes an existing detection point forming the map data stored in the map data storage unit, and a current detection point detected by the non-contact sensor, and
the map data creation unit creates the map data by adding the current detection point satisfying the height condition to the existing detection point.

5. The control system for a work machine according to claim 1, comprising
a collation position data calculation unit that collates detection data of the non-contact sensor and the map data created by the map data creation unit, and calculates collation position data indicating a collation position of the work machine.

6. The control system for a work machine according to claim 5, comprising
a traveling control device that controls, when detection accuracy of the position sensor is decreased, a traveling state of the work machine on the basis of the collation position data calculated by the collation position data calculation unit.

7. A work machine comprising the control system for a work machine according to claim 1.

8. A control method for a work machine, comprising:
acquiring, from a position sensor, detection data of a position of a work machine traveling on a traveling road;
acquiring, from a non-contact sensor, detection data of a position of an object around the work machine; and
creating map data on the basis of a detection point on the object and detection data of the position sensor, the detection point being detected by the non-contact sensor and satisfying a prescribed height condition.
